(19) United States
(12) Patent Application Publication
(10) Pub. No.: US 2007/0193943 A1
(43) Pub. Date: Aug. 23, 2007

(54) Rotating-frame rail for a filtration device and a method for manufacture thereof

(76) Inventor: Serge Kurowski, Neuville-en-Condroz (BE)

Correspondence Address: SUGHRUE MION, PLLC, 2100 PENNSYLVANIA AVENUE, N.W., SUITE 800, WASHINGTON, DC, 20037, US

(21) Appl. No.: 10/598,649

(22) PCT Filed: Mar. 8, 2005
(86) PCT No.: PCT/EP05/51026

§ 371 Date: Sep. 7, 2006

(30) Foreign Application Priority Data
Mar. 10, 2004 (BE) 2004/0132

(51) Int. Cl. B01D 33/00

(52) U.S. Cl. 210/330; 210/328; 210/541; 198/860.1; 198/860.2

(57) ABSTRACT

The invention relates to a rail (1) comprising a rotating frame for a filtration device comprising filter cells which are disposed in the form of a carousel. The invention comprises: a first flange (2) which is cut in the shape of a circular or polygonal ring, a second flange (3) which is cut in the shape of a second circular or polygonal ring segment, a core (10) which is welded transversely to the inner surfaces (4, 6) of the flanges (2, 3) such as to form a H-shaped rail, and a wear plate (8) which is fixed to the outer surface (7) of the second flange. According to the invention, the aforementioned core (10) is formed from at least two steel crossties (11, 12) which are curved or folded parallel to on another and which are welded to the inner surfaces (4, 6) of the flanges (2, 3). Moreover, the second flange (3) and the wear plate (8) are provided with holes (13, 14) in which fixing elements (15) are disposed in order to fix the wear plate to the second flange in a detachable manner.

The present invention relates to a rotating-frame rail for a filtration device with filtration cells disposed in a carousel, comprising

a first flange, cut from a sheet of steel so as to form a first circular or polygonal ring segment and having an external surface, intended to cooperate with at least one filtration cell, and an internal surface,

a second flange, cut from a sheet of steel so as to form a second circular or polygonal ring segment and having an external surface and an internal surface,

a steel web welded transversely to the internal surfaces of the first and second flanges so as to form a rail having a transverse section roughly in an H shape, and

a wear plate, cut from a sheet of steel so as to form a third circular or polygonal ring segment and fixed to the said external surface of the second flange in order to form a contact surface for support rollers.

There have been known for a long time already filtration devices with filtration cells disposed in a carousel, which are in particular in use in the production of phosphoric acid, copper, cobalt, zinc, uranium, etc hydrometallurgy, the washing of active carbon or phosphates, and the filtration of acids in general. Such installations are described for example in U.S. Pat. No. 3,389,800 and BE-A-847088, with filtration cells tilting about a radial axis, and in EP-A-1383588 with filtration cells tilting about a tangential axis.

The cells in these installations are supported by a rotating frame generally comprising two rings each formed by several rails arranged one behind the other in a circular or polygonal manner, these rings resting on support rollers (see in particular U.S. Pat. No. 3,389,800 and BE-A-847088).

The rails forming these rings generally have a cross section in the shape of an H as indicated at the start and are, in general terms not described in these prior patents, provided or not on the external surface of the lower flange with a wear plate welded to the rail.

These rails have the drawback of having very low resistance to torsion and therefore requiring a large number of rollers for supporting the frame, these rollers representing parts of the installation that wear relatively quickly and must therefore be replaced frequently. The result is a high cost for maintenance of the installation. Moreover, when the wear plate is itself worn, which also occurs regularly, it is necessary either to remove the existing wear plate and to reweld a new one, or to replace all the rail, which represents in both cases an expensive operation with prolonged stoppage of the installation. Finally, these rails, formed from welded elements, that is to say which have undergone high stresses during their manufacture, are not machined and the external surfaces therefore remain in the raw state and are defective in their capacity for presenting perfect surface evenness and horizontality for the cells supported and a contact surface well suited to the support rollers.

The aim of the present invention is to develop a rotating-frame rail for a filtration device that avoids these drawbacks and through its structure affords an appreciable reduction in the maintenance costs for the installation.

These problems are resolved according to the invention by a rail as indicated at the start, in which the web is formed from at least two steel cross-ties, curved or bent in a parallel fashion and welded to the said internal surfaces of the flanges, and the second flange and the wear plate have corresponding piercings, through which there are disposed fixing elements that fix the wear plate to the second flange in a detachable manner. Through its at least double web, the support rail offers appreciably improved resistance to torsion and therefore allows a reduction in the number of support rollers for the rotating frame. Moreover, by virtue of a special manufacturing method, indicated below, the second flange, that is to say generally the bottom flange of the rail, can be provided with piercings, which allows detachable fixing of the wear plate on the rails and therefore rapid and economical replacement thereof.

According to an advantageous embodiment of the invention, the first flange and/or the second flange have an external surface planed by machining. Once again, by virtue of the manufacturing mentioned above, the flanges welded to the at least double web and in particular their external surface can be machined, despite the tensions caused by the curving or bending, the cropping and the welding. This machining can consist of a planing that will make it possible to obtain the required horizontality for the cells over the entire periphery of the frame and optimum distribution of the loads on the rollers, which will thus undergo lower stresses and less wear.

Other embodiments of rails according to the invention are indicated in the accompanying claims.

The invention also concerns a rotating frame for a filtration device with filtration cells disposed in a carousel, comprising several rails according to the invention arranged in succession in a circular or polygonal manner.

The invention also relates to a method of manufacturing a rotating-frame support rail for a filtration device with filtration cells disposed in a carousel according to the invention, this method comprising

cropping from a steel sheet a first flange and second flange of the rail and a wear plate so as to give them the form of a ring segment,

curving or bending at least two steel cross-ties in a parallel manner,

welding the said at least two cross-ties parallel to the internal surface of the first and second flanges,

eliminating any residual stresses present in the steel,

producing corresponding piercings through the second flange and the wear plate, and

fixing the wear plate to the external surface of the second flange by detachable fixing elements passed through the aforementioned piercings.

Advantageously the method according to the invention also comprises a planing of the external surfaces of the said first and second flanges, which will be carried out before the aforementioned piercing phase.

The cross-ties and the flanges of the rail are made from steel. Advantageously, these elements are made from stainless steel and, in this case, the stresses are eliminated by peening the welded areas. If these elements are made from carbon steel, preferably an annealing will be carried out at a temperature above 600 oC., preferably around 620 oC. The duration of the annealing is then advantageously around 2 hours.

Particular embodiments of the manufacturing method according to the invention are indicated in the accompanying claims. Other details and particularities of the invention will emerge from the description given below non-limitingly and with reference to the accompanying drawings.

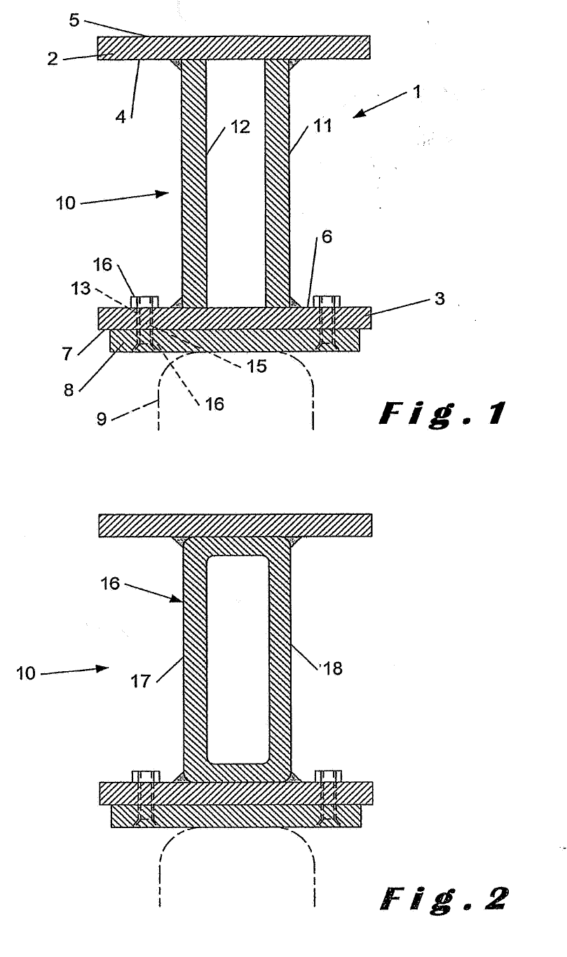

FIG. 1 depicts in transverse section a rotating-frame rail 1 for a filtration device with filtration cells disposed in a carousel. This rail comprises a first flange 2 and a second flange 3. These flanges are cropped from a sheet of steel so as each to form a circular or polygonal ring segment, the rails thus being able to be joined to each other, forming a complete circle or polygon around the pivot of the carousel.

The flange 2 has a internal surface 4 and an external surface 5, the latter being intended to support at least one known filtration cell, not shown, by supporting it directly or by means of a support structure.

The flange 3 also has a internal surface 6 and an external surface 7. A wear plate 8 is fixed to the latter, also cropped from a sheet of steel so as to form a circular or polygonal ring segment. This wear plate 8 is fixed to the flange 3 in order to form a contact surface for support rollers 9 that, in a known manner, turn loosely on a stationary base structure, not shown.

In accordance with the invention, the flange 3 and the wear plate 8 have, as fixing elements, corresponding piercings 13 and 14. Through these it is possible to pass bolts 15 to be screwed in nuts 16 in order to clamp the wear plate 8 against the external surface 7 of the flange 3 of the rail.

The rail 1 also comprises a steel web 10 welded transversely to the internal surfaces 4 and 6 of the first and second flanges 2 and 3. The general form of the transverse section of the rail according to the invention corresponds approximately to an H on its side.

According to the invention, the web is formed, in the example embodiment illustrated, from two steel cross-ties 11, 12, which can be strips of laminated steel. They are curved or bent in accordance with the radius of the carousel so as to remain mutually equidistant, that is to say to extend parallel to each other.

The rotating frame formed by the successive rails 1 is driven in rotation in a manner known per se, for example by a motor/rack system, and runs on the rollers 9, which over time causes wear on the rollers 9 and wear on the wear plate 8.

These rails however offer the great advantage, compared with the rails currently used, of having, by virtue of their at least double web, a much greater resistance to torsion and flexion, which allows the use of a smaller number of rollers, and therefore less replacement of rollers.

Moreover, once the wear plate is worn, it suffices to unscrew it from the rail and to replace it with a new one, which is a simple and inexpensive operation requiring little time, without dismantling the rotating frame itself.

All these advantages have a influence on the service life of the rail itself, which can be assessed at 20-25 years, instead of 5-10 years for the rails according to the prior art.

The result is therefore a enormous economy in the functioning and maintenance of the filtration device in general.

According to a variant embodiment of the rail according to the invention, the web is formed from a steel tube 16 having a rectangular cross section, whose long sides 17 and 18 represent the two cross-ties of a web according to the invention.

In order to fabricate the rails according to the invention, there is provided, as already indicated, a cropping of the two flanges 2 and 3 and of the wear plate 8 from steel sheet so as to give them the appearance of corresponding ring segments, a curving or bending of the two cross-ties 11 and 12 so that they are equidistant, that is to say parallel, and, on the internal surface of the flanges 2 and 3, a welding of the cross-ties 11 and 12.

The rails thus obtained have undergone significant stresses during the curving or bending and welding, and a planing of the external surfaces 5 and 7 of the flanges must often be carried out by deformation cold and using a press, which also causes additional stresses in the rail. On the other hand, after elimination of the residual stresses, for example by peening the welds or by stress relief annealing, piercing and planing by machining become possible, which makes it possible to obtain well finished external surfaces that guarantee the horizontality of the cells, an adjustment of the contact with the rails 9 and optimised distribution of loads thereon.

Provision has been made according to the invention, in the case where the elements of the rail are fabricated from stainless steel, to eliminate the residual stresses by peening of the welded areas. In the case of carbon steel, provision is rather made to eliminate them by annealing, preferably at a temperature above 600 oC., advantageously around 620 oC. It is possible to provide in particular annealing lasting two hours.

It must be understood that the present invention is in no way limited to the forms and embodiments described above and that many modifications can be made thereto without departing from the scope of the accompanying claims.

1. Rotating-frame rail (1) for a filtration device with filtration cells disposed in a carousel, comprising
a first flange (2), cut from a sheet of steel so as to form a first circular or polygonal ring segment and having an external surface (5), intended to cooperate with at least one filtration cell, and an internal surface (4),
a second flange (3), cut from a sheet of steel so as to form a second circular or polygonal ring segment and having an external surface (7) and an internal surface (8),
a steel web (10) welded transversely to the internal surfaces (4, 6) of the first and second flanges (2, 3) so as to form a rail having a transverse section roughly in an H shape, and
a wear plate (8), cut from a sheet of steel so as to form a third circular or polygonal ring segment and fixed to the said external surface (7) of the second flange (3) in order to form a contact surface for support rollers (9),
characterised in that the web (10) is formed from at least two steel cross-ties (11, 12), curved or bent in a parallel fashion and welded to the said internal surfaces (4, 6) of the flanges (2, 3), and in that the second flange (3) and the wear plate (8) have corresponding piercings (13, 14), through which there are disposed fixing elements (15) that fix the wear plate (8) to the second flange (3) in a detachable manner.

2. Support rail according to claim 1, characterised in that the first flange (2) and/or the second flange (3) have an external surface (5, 7) planed by machining.

3. Support rail according to claim 1, characterised in that the web (10) is formed by a tube (16) having a rectangular cross section and long sides (17, 18) forming the said parallel cross-ties.

4. Support rail according to claim 1, characterised in that the said fixing elements are bolts (15) cooperating with nuts (16).

5. Rotating frame for a filtration device with filtration cells disposed in a carousel comprising several rails (1) according to claim 1, arranged in succession in a circular or polygonal manner.

6. Method of manufacturing a rotating-frame support rail for a filtration device with filtration cells disposed in a carousel according to claim 1, comprising
cropping from a steel sheet a first flange and second flange of the rail and a wear plate so as to give them the form of a ring or polygon segment,
curving or bending at least two steel cross-ties in a parallel manner,
welding the said at least two cross-ties parallel to the internal surface of the first and second flanges,
eliminating any residual stresses present in the steel,
producing corresponding piercings through the second flange and the wear plate, and
fixing the wear plate to the external surface of the second flange by detachable fixing elements passed through the aforementioned piercings.

7. Method according to claim 6, characterised in that it also comprises a planing by machining of the external surfaces of the said first and second flanges.

8. Method according to claim 6, characterised in that the rail is made from stainless steel and in that the elimination of the residual stresses consists of a peening of welded areas.

9. Method according to claim 6, characterised in that the rail is made from carbon steel and in that the elimination of the residual stresses consists of a annealing thereof.

10. Method according to claim 9, characterised in that the said annealing takes place at a temperature above 600° C., preferably around 620° C.
